(19) United States
(12) Patent Application Publication
(10) Pub. No.: US 2006/0168858 A1
(43) Pub. Date: Aug. 3, 2006

(54) Mailbox associable graphic media display apparatus and use thereof

(76) Inventor: Curtis P. Taylor, Moreland Hills, OH (US)

Correspondence Address: Justin S. Rerko & Associates, LLC, 19836 Ellsworth Drive, Strongsville, OH, 44149, US

(21) Appl. No.: 11/049,023

(22) Filed: Feb. 2, 2005

(51) Int. Cl. G09F 15/00

(52) U.S. Cl. 40/606.06

(57) ABSTRACT

A disposable display apparatus adapted to be removably associated with a mailbox and display for visual inspection graphic media associated with a theme, such as a holiday-related theme, a season-related theme, a personal event-related theme, a hobby and/or personal interest-related theme, and the like. The apparatus generally includes a flexible member comprising a first surface having graphic media associated with a theme thereon, and a second surface adapted to be removably associated with a mailbox. The apparatus may additionally include a plurality of streamer members extending therefrom, a personalization portion adapted to receive handwriting thereon, a transparent portion adapted to display indicia contained on the mailbox, and other features.

### FIELD OF THE INVENTION

The present invention is directed to a disposable graphic media display apparatus. More particularly, the present invention is directed to a disposable display apparatus adapted to be removably associated with a mailbox and display for visual inspection graphic media associated with a theme.

### BRIEF DISCUSSION OF THE RELATED ART

People often decorate aspects of their home yards and/or properties in various ways with a variety of media types. People are gregarious by nature and enjoy sharing certain information with their community in various ways. For example, the birth of a child is often announced by decorating certain parts of a family's house. Such decorations may include the positioning of a plurality of balloons in a yard associated with the house, especially in proximity to an entrance door, a mailbox, etc., and other similar decorations. By way of additional example, birthdays are often celebrated by decorating houses in similar ways. One popular approach involves the decoration of a lawn with a variety of comical animal-like displays jocularly announcing the fact of the birthday. Similar efforts are observed in connection with reunions, baby showers, wedding showers, graduations, etc.

People also often decorate aspects of their home yards and/or properties with media that illustrates their preferred affiliation with a certain organization. For example, many people are ardent supporters of preferred sports organizations and/or teams and accordingly wave a flag or append other media to their house and/or yard to demonstrate the same to their local community. Similar approaches are taken to share individuals' enthusiasm for other hobbies and pursuits, such as fishing, hunting, golfing, patriotism, and the like.

The passing of seasons and certain holidays are also frequent impetus for decorating homes and/or yards. For example, Christmas is a holiday that inspires an ardent devotion to home decorating for many people. Such decorations often include extensive lighting displays, house and yard mounted media, such as signs and displays illustrating their holiday spirit, etc. Such efforts are often exhibit in connection with other holidays and seasons as well, such as Spring, Summer, Fall, Winter, Thanksgiving, Halloween, Easter, the 4^{th} of July, St. Patrick's Day, New Year's Day, Valentine's Day, etc.

Additionally, media are often positioned in a yard and/or affixed to certain house features to share information with a local community. For example, garage sale signs are often staked into ground to advertise the fact of a garage sale, its location, its hours, etc. Such information displaying media is often also used to indicate the location of a party, such as a birthday party, graduation party, BBQ party, baby shower, wedding shower, wedding, etc.

### BRIEF SUMMARY OF THE INVENTION

In accordance with one example aspect, the present invention is directed to a disposable display apparatus adapted to be removably associated with a mailbox and display for visual inspection graphic media associated with a theme. The apparatus generally includes a flexible member comprising a first surface having graphic media associated with a theme thereon, and a second surface adapted to be removably associated with a mailbox. The display apparatus may suitably also include a plurality of streamer members extending from at least one of a lower edge of the first side portion and a lower edge of the second side portion, and a panel member associable with the flexible member connecting portion, and wherein the panel member comprises graphic media associated with the theme thereon.

In accordance with another example aspect, the present invention is also directed to a retail system for retailing a disposable display apparatus adapted to be removably associated with a mailbox and display for visual inspection graphic media associated with a theme. The system generally includes a disposable display apparatus comprising a flexible member comprising a first surface having graphic media associated with a theme thereon, a second surface adapted to be removably associated with a mailbox, a first side portion, a second side portion, and a connecting portion therebetween; and a cylindrical tube member having the display apparatus removably associated therein in a rolled format.

In accordance with yet another example aspect, the present invention is directed to a disposable display apparatus adapted to be removably associated with a mailbox and display for visual inspection graphic media associated with a theme. The theme is preferably at least one selected from the group consisting of a holiday-related theme, a Christmas-related theme, a Thanksgiving-related theme, a Halloween-related theme, an Easter-related theme, a 4^{th} of July-related theme, a St. Patrick's Day-related theme, a New Year's-related theme, a Valentine' Day-related theme, a Spring season-related theme, a Summer season-related theme, a Fall season-related theme, a Winter season-related theme, a birthday-related theme, a reunion-related theme, a new baby celebration-related theme, a baby shower-related theme, a wedding-related theme, a wedding shower-related theme, a graduation-related theme, a picnic-related theme, a hobby-related theme, a fishing hobby-related theme, a hunting hobby-related theme, a professional sports team-related theme, a professional athlete-related theme, a golf-related theme, a patriotism-related theme, a garage sale-related theme, a yard sale-related theme, and an open house-related theme.

### BRIEF DESCRIPTION OF THE DRAWINGS

These and other features and a more thorough understanding of the present invention may be achieved by referring to the following description and claims, taken in conjunction with the accompanying drawings, wherein:

FIG. 1 is a perspective view of an example mailbox-mountable media display system comprising a mailbox and a media display apparatus associated therewith;

FIG. 2 is perspective and partially exploded view of the example media display apparatus of FIG. 1;

FIG. 3 is a perspective and partially exploded view of an alternate media display apparatus;

FIG. 4 is a perspective view of an alternate mailbox-mountable media display system;

FIG. 5 is a perspective view of another alternate mailbox-mountable media display system;

FIG. 6 is a perspective and exploded view of retail packaging components of the media display apparatus;

FIG. 7 is a perspective and exploded view of alternate retail packaging components of the media display apparatus; and

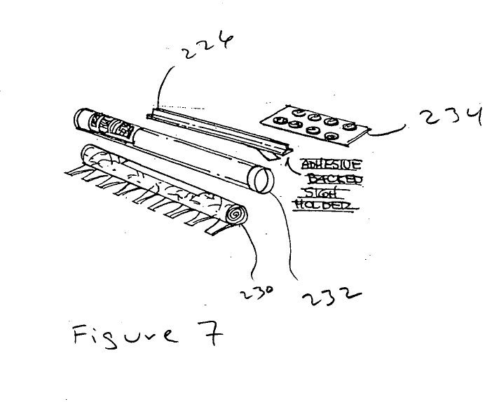

FIG. 8 is a perspective view of an example media display apparatus retail display system.

### DETAILED DISCUSSION OF EXAMPLE EMBODIMENTS

Disclosed according to the present invention are a media display system and a media display apparatus adapted to be associated with a conventional mailbox. The system and apparatus generally enable individuals to display theme-based graphic media to their local community, such as holiday and/or season-related media, personal and/or family event media, hobbies and/or personal interest-related media, miscellaneous media, and the like. Example holiday and/or season-related messages include celebratory seasonal displays (e.g., welcoming the advent of a certain season, such as summer, fall, winter, spring), holiday celebratory displays (e.g., celebrating the occurrence of Christmas, Thanksgiving, Halloween, Easter, 4^{th} of July, St. Patrick's Day, New Year's Holiday, Valentine's Day, Hanukkah, etc.). Example personal and/or family messages include, but are not limited to, announcements of birthdays, comic birthday announcements, reunion information, new baby announcements, baby shower announcements, wedding shower announcements, graduation congratulations and announcements, gathering locale identification (e.g., identifying the site of the media display system as the site of a party or similar gathering), etc. Example hobbies and/or personal interest-related messages include, but are not limited to, display associated with a favored sports team, fishing and/or hunting-themed displays, golf-themed displays, patriotic displays, etc. Example miscellaneous media messages include, but are not limited to, announcements of garage/yard sales and provision of certain information relating thereto, announcements of open houses, house sales, etc. Thus, the media display system and media display apparatus of the present invention enables individuals to share any of a plurality of messages with their local community.

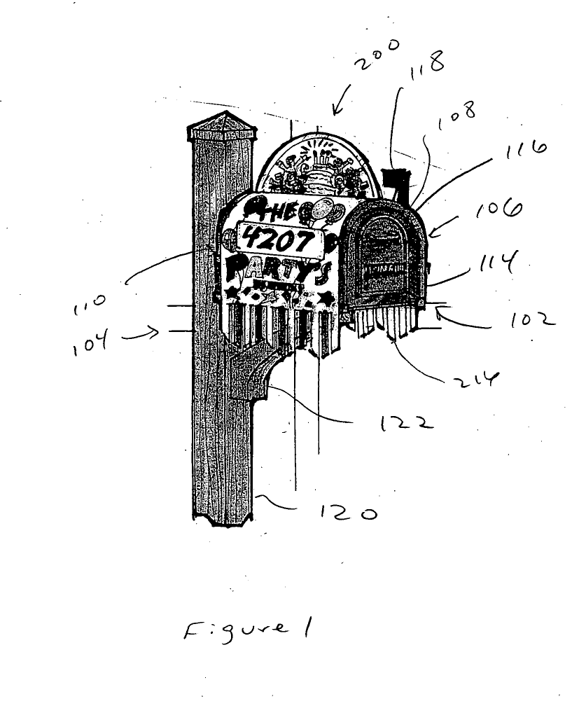

With reference to FIG. 1, illustrated is an example media display system 100 generally including a mailbox 102 and a media display apparatus 200. By way of example only and not to limit the present invention, the mailbox 102 is a generally rectangular member having a pair of opposed and spaced apart side walls 104, 106, a top wall 108, a rear wall 110, a bottom wall 112 and an access door 114. The side walls 104, 106 are preferably generally rectangular members elongate along their longitudinal axes and are preferably maintained in a spaced apart relationship to define therebetween an inner cavity for the temporary storage of items therein, such as mail, and the like. The top wall 108 is preferably also a generally rectangular member elongate along its longitudinal axis and associated along its longitudinal edges with top edges of the side walls 104, 106. Even more preferably, the top wall 108 is a curved member having an arcuate portion extending along its longitudinal axis, thereby disposing the side walls 104, 106 and top wall 108 in a generally letter “U”-shaped cross sectional configuration. The mailbox 102 also includes the rear wall 110 as a generally rectangular member preferably including a domed upper portion generally corresponding to the arcuate configuration of the top wall 108. The rear wall 10 is disposed along a rear portion of the mailbox 102, preferably along rear edges of the side walls 104, 106 and the top wall 108. The bottom wall 112 defines a lower portion of the mailbox 102 and is disposed along lower edges of the side walls 104, 106 and generally perpendicular thereto.

The mailbox 102 also includes the access door 114 for providing access to the mailbox 102 inner cavity. The access door 114 is preferably pivotally disposed relative to the mailbox 102, and even more preferably is pivotally associated with a front edge of the bottom wall 112. Accordingly, the access door 114 is preferably pivotable between a range of positions including an open position for providing access to the inner cavity, in which the door 114 is pivoted downward and in generally parallel relationship to the bottom wall 112, and a closed position for preventing access to the inner cavity, in which the access door 114 is pivoted upward and disposed in generally abutting relationship with front edges of the side walls 104, 106 and the top wall 108. The access door 114 may suitably include a handle 116 associated therewith for facilitating manipulation of the access door 114.

The mailbox 102 may suitably include an indicating means for enabling an individual to ascertain whether mail has been deposited therein, without requiring the individual to inspect the inner cavity thereof. With regard to an example embodiment, the indicating means may suitably be provided as a flag 118 pivotally and/or rotatably associated with a side wall 104 or 106 of the mailbox 102, which flag 118 is pivotable from a down position, conventionally known to correspond to an empty inner cavity situation, and an up position, conventionally known to correspond to an inner cavity having mail therein situation.

The mailbox 102 may suitably be positioned in any appropriate location, with regard given to the need for easy access for mail delivery. One conventional approach involves the positioning of the mailbox 102 in proximity to a border of an individual's land property that is abutting a street. Accordingly, with reference to FIG. 1, the mailbox 102 may suitably be supported in an elevated state by association with a vertical beam 120 that may suitably be interjected into the land and be maintained vertically relative thereto. The mailbox 102 is preferably associated with the vertical beam 120 perpendicularly, according to which the rear wall 110 abuts the beam 120 and one or more fasteners pass through the rear wall 110 and sink into the beam 120. Alternatively, the mailbox 102 may suitably be positioned atop the beam 120, with one or more fasteners passing through the bottom wall 112 and sinking into the beam 120. Additionally yet, the vertical beam 120 may include laterally projecting therefrom a support beam 120. Accordingly, the mailbox 102 may suitably be supported by both the support beam 120 and the vertical beam 120.

It is to be appreciated that the foregoing discussion of the mailbox 120 and beams 120, 122 are by way of example only and are not to be construed as limitations on the scope of the present invention. For example, the mailbox 102 need not necessarily be associated with a beam and may suitably be fastened to a portion of a dwelling structure. Additionally, the mailbox 102 need not conform to the particular configuration as hereinabove described. For example, the mailbox 102 may suitably be more fully rectangular in overall shape and lack an arcuate portion in the top wall 108. By way of additional example, the mailbox 102 may suitably be provided as a generally square member, a member having a pyramidal top wall, and the like. According to yet an additional example, the mailbox 102 access door 114 may suitably be pivotally associated with an upper edge of one of the side walls 104, 106 and perform a dual function of both providing the top wall of the mailbox 102 and the access door. One of ordinary skill will readily appreciate the myriad of configurational possibilities for a mailbox.

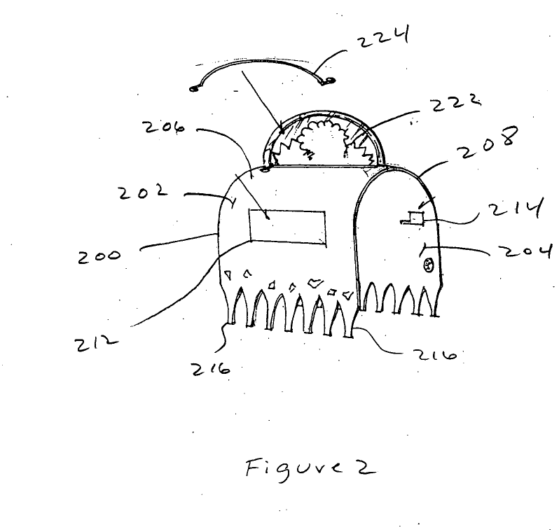

The media display system 100 also includes the media display apparatus 200, as illustrated with reference to an example embodiment in FIG. 2. In a preferred embodiment, the display apparatus 200 is provided as a generally rectangular and generally thin and flat member adapted to overlie the mailbox 102 and thereby expose the media thereon for visual inspection and display. For ease of illustration, the apparatus 200 can be conceptualized as including a first side portion 206, a second side portion 208 and a connecting portion 210. Accordingly, the display apparatus 200 is adapted to be releasably engaged with the mailbox 102 in a configuration by which the apparatus 200 connecting portion 210 overlies at least a portion, preferably substantially all, of the mailbox 102 top wall 108, the apparatus 200 first side portion 206 overlies at least a portion, preferably substantially all, of the mailbox 102 side wall 104, and the apparatus 200 second side portion 208 overlies at least a portion, preferably substantially all, of the mailbox 102 side wall 106.

The media display apparatus 200 preferably includes a media display surface 202 and a mailbox-engaging surface 204. The media display surface 202 is a surface of preferably generally rectangular display apparatus 200 that is adapted to be exposed for visual inspection when the apparatus 200 is associated with the mailbox 102, and accordingly includes thereon graphic media as described hereinabove. The graphic media may suitably be provided on the media display surface 202 according to any of a plurality of known techniques, such as hand imprinting, data processing peripheral device (e.g., laser printer, dot matrix printer, inkjet printer, and the like) outputting, professional printing preparation techniques, lithography, heat stamping, engraving, embossing, embroidery, and the like.

The media display surface 202 may suitably include any desired graphic media and may additionally include a portion thereof reserved for the receipt of personalized, handwritten graphic media. With continued reference to FIG. 2, the media display surface 202 may suitably include a personalization portion 212 adapted to receive thereon handwritten media, such as, for example, an address number, an individual's name, a further personalization of the graphic media presented on the media display surface 202, and the like. The personalization portion 212 may suitably be provided as a delineated portion along one or more of the display surface 202 first side portion 206 and the second side surface 208, and may additionally be a portion of the media display apparatus 200 particularly adapted to receive and retain, preferably in a manner that is resistant to environmental elements (e.g., wind, rain, snow, sleet, etc.) handwriting thereon, the components and composition of which is well known to one of ordinary skill in the art. Alternatively, the personalization portion 212 may suitably be provided as a transparent portion adapted to enable visual inspection through the apparatus 200 of certain information, such as a street address, maintained on the mailbox 102.

The apparatus 200 mailbox-engaging surface 204 is preferably a surface of the apparatus 200 disposed in opposed and generally parallel relationship to the media displaying surface 202, and is a portion of the apparatus 200 adapted to lie in contact with at least a portion of, preferably substantially all of, the mailbox 102 top wall 108 and side walls 104, 106.

The media display apparatus 200 may suitably include an aperture 214 fashioned therein to permit the operation of the mailbox 102 flag 118. As shown in FIG. 2, the aperture 214 may be positioned anywhere along the apparatus 200 as necessary, such as in the second side portion 208 of the apparatus 200, a location typically corresponding to the location of the flag 118 on the mailbox 102.

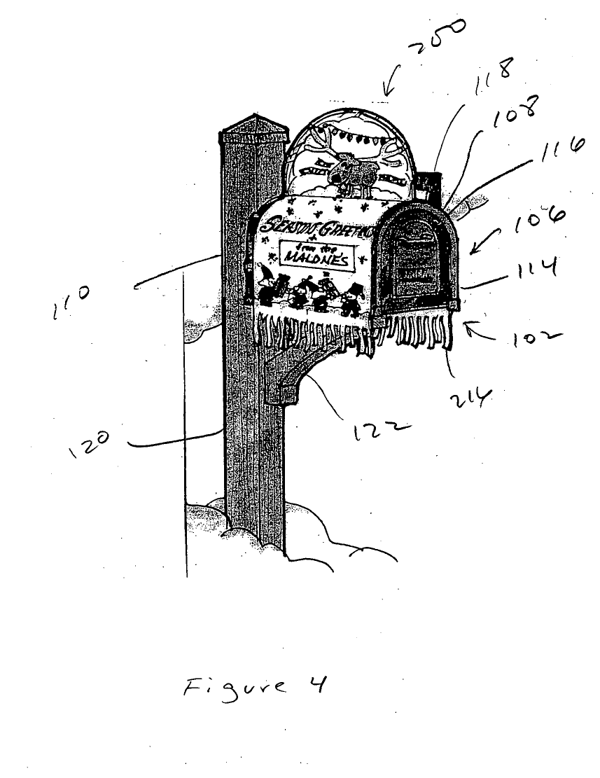

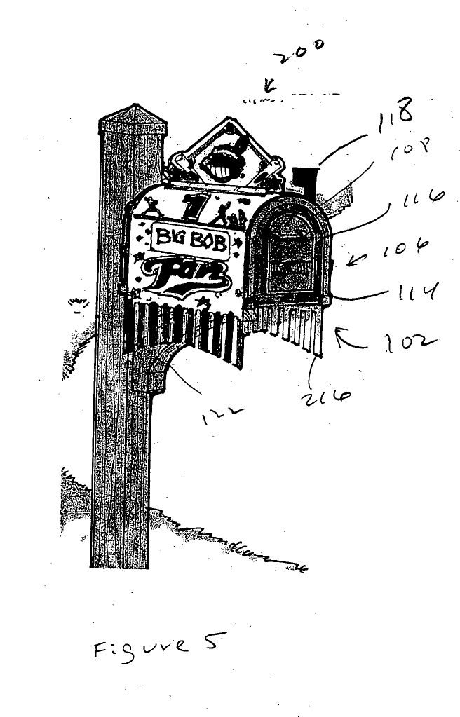

With regard to a preferred embodiment, the media display apparatus 200 suitably also includes a plurality of streamer-like elements 216 to increase the aesthetic appeal of the media display apparatus 200. The streamers 216 are preferably provided as a plurality of strips extending from lower edges of the first side portion 206 and the second side portion 208, in a manner for permitting the streamers 216 to extend downward and below the mailbox 102 when the apparatus 200 is installed thereon. FIG. 2 illustrates an embodiment of the streamers 216 according to which the streamers 216 are provided as a plurality of downwardly tapered projections. Various other configurations of the streamers 216 are possible, such as a wavy configuration, as shown in FIG. 4, a multi-pyramidal configuration, as shown in FIG. 1, a generally arcuate configuration, as shown in FIG. 5, and the like.

The media display apparatus 200 is suitably constructed by any appropriate technique and of any appropriate material. For example, the apparatus 200 may suitably be constructed from a plastic, such as Mylar, displaying preferred characteristics of environmental durability (i.e., being resistant to rain, wind, snow, sleet, sun exposure, and the like) and flexibility. By way of additional example, the apparatus 200 may suitably be provided as a durable paper material that may additionally be protected with appropriate lamination, as known in the art.

With reference to an example embodiment, the media display apparatus 200 suitably also includes a supplementary media display area provided as a projecting portion 220 and adapted to contain various graphic media thereon, as previously described. The projecting portion 220 is preferably adapted to vertically extend from the connecting portion 210 of the media display apparatus 200 and extend along the longitudinal axis thereof, thereby exposing its display surface 222 for easy visual inspection. More preferably, the display surface 222 is oriented relative to the media display apparatus 200 generally co-planar to the first side portion 206 and the second side portion 208, thereby cohesively presenting the media contained on the various surfaces.

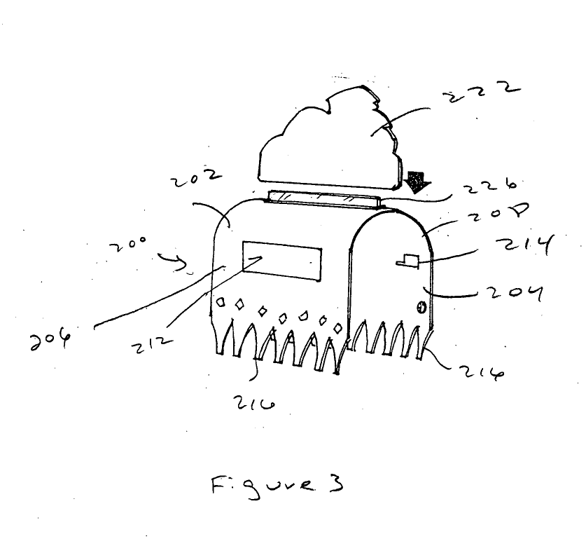

The projecting portion 220 may suitably be associated with the media display apparatus 200 through any manner. For example, the projecting portion 220 may suitably be a member integral with the apparatus 200. By way of additional example, the projecting portion 220 may be removably associable with the apparatus 200. With continued reference to the removably associable embodiment and FIG. 3, the apparatus 200 preferably includes a receiving base 226 associated with the connecting portion 210 thereof, which base 226 suitably includes an elongate slot therein adapted to receive and secure the projecting portion 220 therein. The base 226 may be a member integral with the apparatus 200, may be provided as a distinct component separately associable with the apparatus 200 with an appropriate fastener (e.g., glue, hook and loop fastener, and the like), and the like. With additional reference to the removably associable embodiment and FIG. 2, the apparatus 200 preferably includes a generally arcuate rod-like member 224 adapted to overlie edge portions of the projecting portion 220 engage, with its ends, the connecting portion 210. The connecting portion 210 may additionally include a partial slot therein for receiving and securing a portion of a lower edge of the projecting portion 220. The rod 224 may suitably be rigidly affixed to the apparatus 200, or may suitably be removably associable with the apparatus 200. For example, the rod 224 is preferably provided as a separate component that, once the projecting portion 220 has been associated with the connecting portion 210, is positioned perimetrically around the projecting portion 220 and opposite ends thereof are fastened to the connecting portion 220 through, e.g., association with a connecting portion 220 aperture, fixation with an appropriate adhesive, and the like. The projecting portion 220 may additionally include a plurality of holes therein for increasing the portion's 220 resistance to wind-based dislocation.

The media display apparatus 200 is preferably removably associable with the mailbox 102 through any appropriate means. For example, hook and loop fasteners may suitably be conventionally secured to the mailbox 102 surface and the mailbox engaging surface 204, and thereby enable selective dissociation of the apparatus 200 from the mailbox 102. Various other disengageable fasteners are contemplated and by way of example include, but are not limited to, double sided tape, double coated foam tape, epoxy-based adhesives that may suitably be temperature sensitive, removable adhesives generally sold under the trademark COMMAND from 3M (St. Paul, Minn.), permanent adhesives, tacky and generally gummy mastic-like substances, and the like.

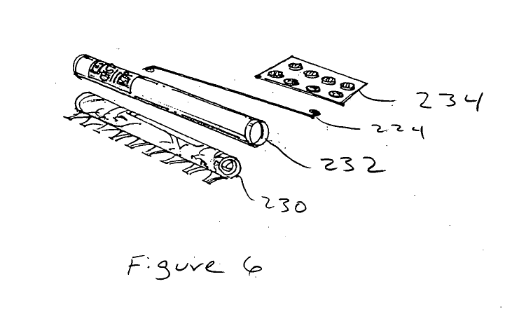

The media display apparatus 200 of the present invention is suitably adapted for simplified retail packaging and promotion. With reference to FIG. 6 and as previously described, the media display apparatus is preferably constructed of a flexible material and accordingly is adapted to be provided in rolled form 230 for retail packaging, which packaging is preferably provided as an elongate and generally cylindrical tube 232 adapted to receive the rolled apparatus 230 therein. The tube 232 may suitably be provided of a size and configuration sufficient for receiving one or more of the rolled apparatus 230, the rod 224, the receiving base 226, the projecting portion 220, a strip of provided adhesive 234, and the like. However, it is to be appreciated that the media display apparatus 200 may suitably be packaged in any manner as desired, such as in a flat manner to display the graphic media thereon, and the like.

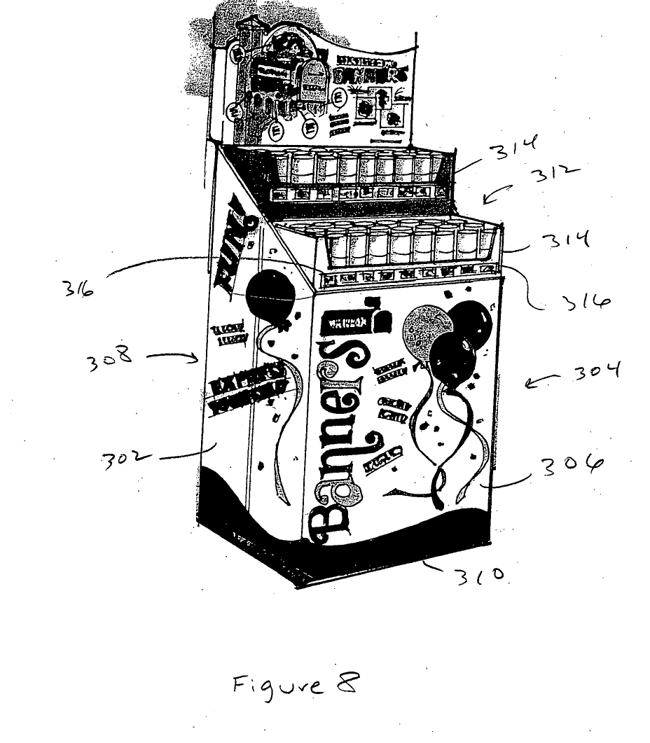

With reference to FIG. 8, illustrated is an example retail point of purchase display stand 300. The stand 300 is preferably a generally rectangular member open along its top to receive and display the tubes 232 therein, and generally includes a pair of opposed side walls 302, 304, a pair of opposed front and rear walls 306, 308, a bottom wall 310, and an open top portion 312. Preferably, the top portion 312 is segmented into two portions 314, each adapted to maintain a plurality of vertically disposed media display apparatus 200-containign tubes 232 therein. Even more preferably, the stand 300 is adapted to contain a plurality of different types of media display apparatus 200, each type corresponding to a different graphic media content. Like apparatus 200 are preferably arranged in columns in the display 300, with each column having an indicium 316 associated therewith for enabling a consumer to discern the type of media contained in a particular display 300 column.

Although the invention has been described with regard to certain preferred example embodiments, it is to be understood that the present disclosure has been made by way of example only, and that improvements, changes and modifications in the details of construction and the combination and arrangement of parts may be resorted to without departing from the spirit and scope of the invention. Such improvements, changes and modifications within the skill of the art are intended to be covered by the scope of the appended claims.

What is claimed is:

1. A disposable display apparatus adapted to be removably associated with a mailbox and display for visual inspection graphic media associated with a theme, wherein the apparatus comprises:
a flexible member comprising a first surface having graphic media associated with a theme thereon, and a second surface adapted to be removably associated with a mailbox.

2. The display apparatus of claim 1 further comprising a temporary and non-permanent adhesive associable with the second surface and adapted to releasably engage the display apparatus with the mailbox.

3. The display apparatus of claim 1, wherein the flexible member further comprises a first side portion, a second side portion and a connecting portion therebetween.

4. The display apparatus of claim 1, wherein the flexible member is constructed of Mylar plastic.

5. The display apparatus of claim 3 further comprising a plurality of streamer members extending from at least one of a lower edge of the first side portion and a lower edge of the second side portion.

6. The display apparatus of claim 3 further comprising a personalization portion associated with the flexible member first surface and adapted to receive handwriting thereon and display the handwriting for visual inspection.

7. The display apparatus of claim 3 further comprising a transparent portion associated with at least one of the flexible member first side portion and the second side portion, and wherein the transparent portion is adapted to display for visual inspection indicia contained on the mailbox.

8. The display apparatus of claim 1, wherein the flexible member comprises an aperture therethrough adapted to permit manipulation of a mailbox flag member.

9. The display apparatus of claim 3 further comprising a panel member associable with the flexible member connecting portion, and wherein the panel member comprises graphic media associated with the theme thereon.

10. The display apparatus of claim 9 further comprising securing means adapted for securing the panel member to the flexible member connecting portion.

11. The display apparatus of claim 9, wherein the theme is at least one selected from the group consisting of a holiday-related theme, a Christmas-related theme, a Thanksgiving-related theme, a Halloween-related theme, an Easter-related theme, a 4^{th} of July-related theme, a St. Patrick's Day-related theme, a New Year's-related theme, a Valentine' Day-related theme, a Spring season-related theme, a Summer season-related theme, a Fall season-related theme, a Winter season-related theme, a birthday-related theme, a reunion-related theme, a new baby celebration-related theme, a baby shower-related theme, a wedding-related theme, a wedding shower-related theme, a graduation-related theme, a picnic-related theme, a hobby-related theme, a fishing hobby-related theme, a hunting hobby-related theme, a professional sports team-related theme, a professional athlete-related theme, a golf-related theme, a patriotism-related theme, a garage sale-related theme, a yard sale-related theme, and an open house-related theme.

12. A retail system for retailing a disposable display apparatus adapted to be removably associated with a mailbox and display for visual inspection graphic media associated with a theme, wherein the system comprises:
a disposable display apparatus comprising a flexible member comprising a first surface having graphic media associated with a theme thereon, a second surface adapted to be removably associated with a mailbox, a first side portion, a second side portion, and a connecting portion therebetween; and
a cylindrical tube member having the display apparatus removably associated therein in a rolled format.

13. The retail system of claim 12 further comprising a temporary and non-permanent adhesive associable with the second surface and adapted to releasably engage the display apparatus with the mailbox.

14. The retail system of claim 12, wherein the flexible member further comprises a plurality of streamer members extending from at least one of a lower edge of the first side portion and a lower edge of the second side portion.

15. The retail system of claim 14, wherein the flexible member further comprises a personalization portion associated with the flexible member first surface and adapted to receive handwriting thereon and display the handwriting for visual inspection.

16. The retail system of claim 14, wherein the flexible member further comprises a transparent portion associated with at least one of the flexible member first side portion and the second side portion, and wherein the transparent portion is adapted to display for visual inspection indicia contained on the mailbox.

17. The retail system of claim 12, wherein the flexible member further comprises an aperture therethrough adapted to permit manipulation of a mailbox flag member.

18. The retail system of claim 12, wherein the display apparatus further comprises a panel member associable with the flexible member connecting portion, wherein the panel member comprises graphic media associated with the theme thereon, and a securing means adapted for securing the panel member to the flexible member connecting portion.

19. The retail system of claim 18, wherein the theme is at least one selected from the group consisting of a holiday-related theme, a Christmas-related theme, a Thanksgiving-related theme, a Halloween-related theme, an Easter-related theme, a 4^{th} of July-related theme, a St. Patrick's Day-related theme, a New Year's-related theme, a Valentine' Day-related theme, a Spring season-related theme, a Summer season-related theme, a Fall season-related theme, a Winter season-related theme, a birthday-related theme, a reunion-related theme, a new baby celebration-related theme, a baby shower-related theme, a wedding-related theme, a wedding shower-related theme, a graduation-related theme, a picnic-related theme, a hobby-related theme, a fishing hobby-related theme, a hunting hobby-related theme, a professional sports team-related theme, a professional athlete-related theme, a golf-related theme, a patriotism-related theme, a garage sale-related theme, a yard sale-related theme, and an open house-related theme.

20. The retail system of claim 19 further comprising a point of purchase display apparatus adapted to support a plurality of cylindrical tube members therewith.
